(19) United States
(12) Patent Application Publication
(10) Pub. No.: US 2024/0378496 A1
(43) Pub. Date: Nov. 14, 2024

(54) KNOWLEDGE DISTILLATION FOR FAST ULTRASOUND HARMONIC IMAGING

(71) Applicant: CANON MEDICAL SYSTEMS CORPORATION, Tochigi (JP)

(72) Inventors: Ting XIA, Vernon Hills, IL (US); Jian ZHOU, Vernon Hills, IL (US); Liang CAI, Vernon Hills, IL (US); Zhou YU, Vernon Hills, IL (US); Tomohisa IMAMURA, Otawara-shi (JP); Ryosuke IWASAKI, Otawara-shi (JP); Hiroki TAKAHASHI, Nasushiobara-shi (JP)

(73) Assignee: CANON MEDICAL SYSTEMS CORPORATION, Tochigi (JP)

(21) Appl. No.: 18/361,238

(22) Filed: Jul. 28, 2023

Related U.S. Application Data
(60) Provisional application No. 63/500,847, filed on May 8, 2023.

(51) Int. Cl. G06N 20/00

(52) U.S. Cl. CPC G06N 20/00

(57) ABSTRACT

A method for harmonic imaging is provided and includes inputting first training ultrasound data, including a fundamental component and a harmonic component, to each of a plurality of teacher models, and training each teacher model with the first training ultrasound as teacher input data and second training ultrasound data, including the harmonic component, as teacher target data; acquiring, for each teacher, corresponding first estimated data output from the teacher model, in response to input of first ultrasound data to the teacher model; selecting a first particular teacher model by evaluating the corresponding first estimated data output from each of the trained teacher models; and training a student model with the first ultrasound data as student input data and the corresponding first estimated data of the selected first particular teacher model as student target data.

### CROSS-REFERENCE TO RELATED APPLICATIONS

This application claims the benefit of priority to provisional Application No. 63/500,847 filed May 8, 2023, the entire contents of which are incorporated herein by reference. Further, related U.S. patent application Ser. No. 18/296,840, filed Apr. 6, 2023, is incorporated herein by reference in its entirety.

### BACKGROUND

### Field

The present disclosure is directed to a strategy in which, among several teacher model results, the best teacher model's knowledge is transferred to a student model having a smaller network than the teacher model. For student model training, only the best teacher model results for the given inputs are used. Thus, the student can learn from multiple teachers and always guarantee to learn from the known best teacher for various inputs.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

In ultrasound harmonic imaging, higher order harmonics could provide images with significantly reduced artifacts, improved contrast-to-noise ratio and improved lateral resolution. For some anatomic structures such as blood vessels, a higher order harmonic image with improved contrast is desired. e.g., third harmonic imaging could provide images with fewer artifacts and improved resolution compared with second harmonicsimages. For example, FIG. 1A illustrates a conventional ultrasound image. In contrast, FIG. 1B illustrates an example third-order harmonic image.

As ultrasound system becomes more flexible and affordable in hospitals and medical clinics, it is desirable to have harmonic imaging with high image quality and accelerated imaging speed. Recently, deep learning-based technology provides a good solution to improve harmonic imaging with superior image quality and fast acquisition. Deep learning could help improve harmonic image quality via sending out fewer pulses with desired phases sequentially into the tissue along the same line, and improving acquisition frame-rate at the same time.

The deep-learning based framework can directly use second or third harmonics (i.e., IQ2 and IQ3), or alternatively, use IQ data containing more fundamental frequencies, such as IQ0, IQ1, and IQ2, to get higher-order or combined harmonic images. Such a frame-work can be feature-aware, depth-dependent, and customized for patients with different BMI and/or demographic information.

However, one problem is that, usually, the deep neural networks require deeper or wider network structures that involve massive computational and memory costs. Thus, their large memory and numerical costs prohibits applying deep neural networks to real-world solutions, especially for high-frame rate real-time imaging. Reducing the model size without significant loss in performance metrics is crucial for time and memory-efficient ultrasound imaging. This is also especially useful for portable ultrasound, where memory size, inference speed, and network bandwidth are all strictly constrained.

To develop lightweight models, many previous attempts in other fields have been made, including using an efficient architecture, model quantization, pruning, and knowledge distillation. However, none of those approaches are specifically designed for harmonic ultrasound imaging, tailored for ultrasound imaging properties.

For example, most current knowledge distillation models are designed for classification problems. In addition, a student model performance can degrade when the gap between the student model and the teacher model is large, and the student model could be only suboptimal in some cases, but not for all datasets, due to data diversity. This is especially common for ultrasound imaging, where a user can freely change scanning depth, a number of beams, the focus, the frequencies, the imaging anatomy, the gain, etc. Thus, it is desirable to have a more robust student model with better generalization capability for ultrasound imaging task. Accordingly, one object of the present disclosure is a novel knowledge distillation to reduce the required computational resources, simplify the training process, and improve the ultrasound harmonic imaging performance.

### SUMMARY

In one aspect, there is provided a method that includes inputting first training ultrasound data, including a fundamental component and a harmonic component, to each of a plurality of teacher models, and training each teacher model of the plurality of teacher models with the first training ultrasound as teacher input data and second training ultrasound data, including the harmonic component, as teacher target data; acquiring, for each teacher model of the plurality of the trained teacher models, corresponding first estimated data output from the teacher model, in response to input of first ultrasound data to the teacher model; selecting a first particular teacher model, of the plurality of trained teacher models, by evaluating the corresponding first estimated data output from each of the trained teacher models; and training a student model with the first ultrasound data as student input data and the corresponding first estimated data of the selected first particular teacher model as student target data.

In a further aspect, there is provided an apparatus that includes processing circuitry configured to input first training ultrasound data, including a fundamental component and a harmonic component, to each of a plurality of teacher models, and train each teacher model of the plurality of teacher models with the first training ultrasound as teacher input data and second training ultrasound data, including the harmonic component, as teacher target data; acquire, for each teacher model of the plurality of the trained teacher models, corresponding first estimated data output from the teacher model, in response to input of first ultrasound data to the teacher model; select a first particular teacher model, of the plurality of trained teacher models, by evaluating the corresponding first estimated data output from each of the trained teacher models; and train a student model with the first ultrasound data as student input data and the corresponding first estimated data of the selected first particular teacher model as student target data.

In a further aspect, there is provided a method that includes obtaining first ultrasound data, including a fundamental component and a harmonic component, as input ultrasound data and second ultrasound data, including the harmonic component, as target output ultrasound data corresponding to the first ultrasound data; inputting the first ultrasound data to a previously trained teacher model to generate teacher output ultrasound data; inputting the first ultrasound data to a student model to generate student output ultrasound data; calculating a loss value of a loss function based on the generated teacher output ultrasound data, the generated student output ultrasound data, and the target output ultrasound data; and updating parameters of the student model based on the calculated loss value.

In a further aspect, there is provided an apparatus that includes processing circuitry configured to obtain first ultrasound data, including a fundamental component and a harmonic component, as input ultrasound data and second ultrasound data, including the harmonic component, as target output ultrasound data corresponding to the first ultrasound data; input the first ultrasound data to a previously trained teacher model to generate teacher output ultrasound data; input the first ultrasound data to a student model to generate student output ultrasound data; calculate a loss value of a loss function based on the generated teacher output ultrasound data, the generated student output ultrasound data, and the target output ultrasound data; and update parameters of the student model based on the calculated loss value.

### BRIEF DESCRIPTION OF THE DRAWINGS

FIG. 1A illustrates an example conventional ultrasound, FIG. 1B illustrates an example third order harmonics;

FIG. 2 is a system diagram for an ultrasound imaging system;

FIG. 3 illustrates a method of ultrasound tissue harmonic imaging;

FIG. 4 is a flow diagram for off-line knowledge distillation;

FIG. 5 is a flow diagram for online self-knowledge distillation;

FIGS. 6 and 7 are flowcharts of a knowledge distillation training process, according to an exemplary aspect of the disclosure;

FIG. 8 is a flowchart for an inferencing step, according to an exemplary aspect of the disclosure;

FIG. 9 is a flowchart of a method of training a student model for ultrasound harmonic imaging, according to exemplary aspects of the disclosure;

FIG. 10 is a flowchart of the calculating step of FIG. 9;

FIG. 11 is a flowchart of the updating step of FIG. 9;

FIG. 12 is a flowchart and for an inferencing step, according to an exemplary aspect of the disclosure;

FIG. 13 is a block diagram illustrating an example computer system 204 for implementing the machine learning training and inference methods according to an exemplary aspect of the disclosure.

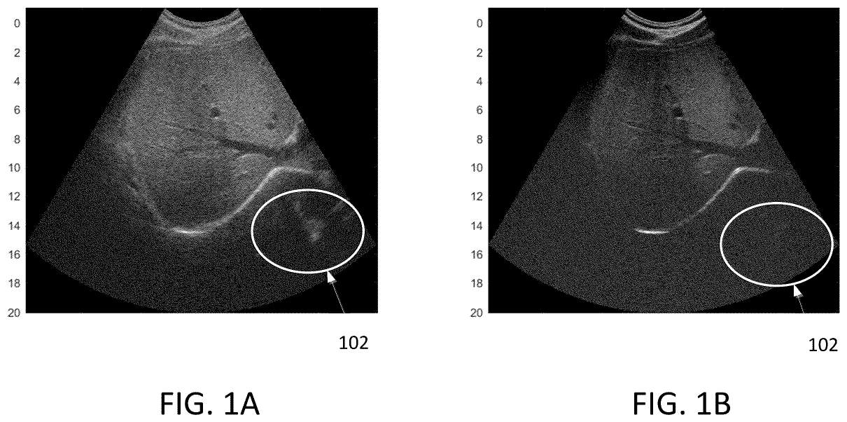

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

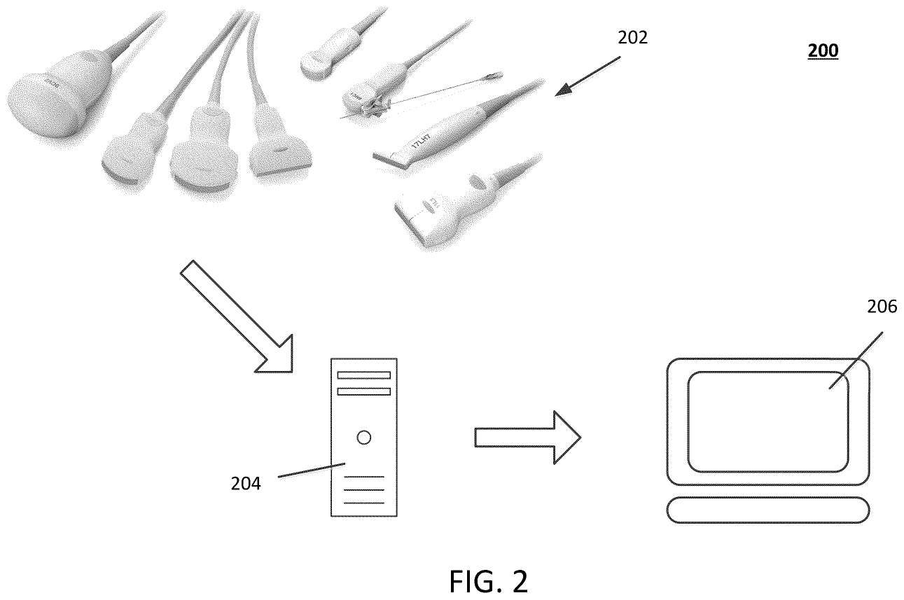

FIG. 2 is a system diagram for an ultrasound imaging system. An ultrasound imaging system 200 can include any of a range of transducers 202. Types of transducers include convex, linear, and sector, as well as those designed for a special purpose. The signals received by a transducer 202 are processed in a computer system 204. The ultrasound imaging system 200 can also include multi-harmonic compounding in which signals from individual beams are merged with overlapping data from adjacent beams.

Ultrasound images are created from sound waves at frequencies above the range audible to humans, typically on the order of 1-10 MHz or above. A transducer 202 emits high frequency waves and records the reflected waves (fundamental frequency), bounced back from interfaces in the tissue, as a series of time-domain signals. One type of ultrasound image is a brightness image, also known as a B-mode image, which is a grayscale, intensity-based representation of the object.

The raw signals that the transducer 202 receives are in the radiofrequency range and are known as radiofrequency (RF) data. A series of signal processing steps are performed in the computer system 204 to convert from the RF data to the ultrasound image, such as a B-mode image. One pre-processing step is to demodulate the RF data to baseband and decimate the signal to reduce the bandwidth required to store the data. This new signal is referred to as an in-phase and quadrature phase (IQ) signal, and is typically represented with complex numbers. In this disclosure, the term IQ and RF data are used interchangeably since they both represent the raw data from the transducer, but in different formats. In addition, embodiments of the deep neural networks of the present disclosure are configured to take as input either the IQ data or an ultrasound image that is based on the IQ data.

The computer system 204 can be embedded in a portable ultrasound machine, can be a remote server, or can be a cloud service that is accessed through the Internet. The ultrasound imaging system 200 includes at least one display device 206 for displaying one or more ultrasound images. The display device 206 can be any of an LCD display, an LED display, an Organic LED display, etc. The display size and resolution are sufficient to display the ultrasound images that are output by the computer system 204.

The following processing methods can be performed by the above-described computer system 204.

In one embodiment, as described in more detail below, the best-trained teacher model, of a plurality of teacher models, is used for knowledge distillation. This idea is implemented for off-line knowledge distillation, and, alternatively, can be used for online self-knowledge distillation.

In one embodiment, in the off-line knowledge distillation, the method first trains a series of teacher models using heavy and powerful deep networks on large-scale datasets. Convolutional neural networks (CNN) have been used in visual recognition tasks. CNNs can be trained with a large training set of images, for example, one million training images as in the ImageNet dataset. ImageNet had 8 layers and millions of parameters. Very heavy and powerful deep convolutional networks can be used for large-scale image recognition. The deep neural network can be, for example, any deep neural network for vision. As mentioned above, convolutional neural networks have demonstrated superior results, and in particular the U-Net architecture enables training with a smaller dataset than a full convolutional neural network. Also, other types of deep neural networks, including a multilayered perceptron or a vision transformer may be used to implement a deep neural network.

Then, among the teacher model results, the best teacher's knowledge, for a given set of training data, is transferred to a student model having a small network, e.g., with fewer layers and parameters. For student model training, only the best teacher model results for the given inputs are used. The best teacher model is the network that has the highest accuracy, for example, but other criteria can be used. Thus, the student can learn from multiple teachers and always be guaranteed to learn from the known best teacher for various sets of training data. This strategy can also generate more training data pairs for the student model training when the ground truth target data is missing, for example. This enables effective data augmentation to increase data diversity (e.g., various imaging conditions, frequencies, the imaging depth, the number of beams, etc.)

In one embodiment, in online self-knowledge distillation, a student network is trained progressively by distilling its own knowledge without a pre-trained “teacher” network. To use the concept of best teacher, the student model is updated using the best past student model to guide the training process for the present model. This strategy uses a simple network structure and enhances the generalization capability of the model. This is also very useful to reduce the gap between the student model and the “teacher” model, making the network more robust in various imaging conditions yet with lightweight structure.

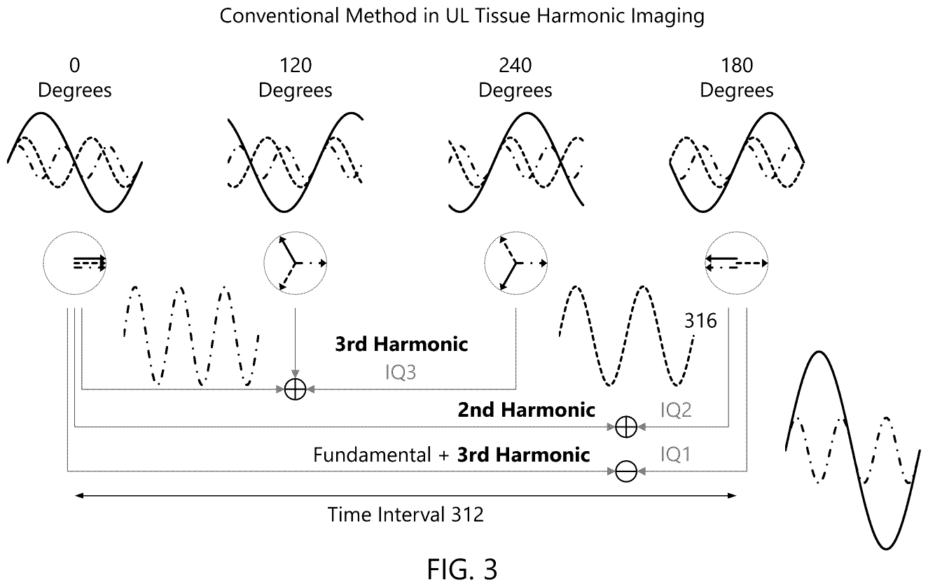

FIG. 3 illustrates a method of ultrasound tissue harmonic imaging. In order to get more signal in the ultrasound far field image, an image can be obtained for both second-order harmonics and third-order harmonics. As described above, one method is the DTHI method, in which two pulses are transmitted simultaneously at different frequencies, referred to as f₁ and f₂. In addition to their second harmonic frequencies (2f₁ and 2f₂), among others, the sum and the difference of the transmitted frequencies (f₂+f₁ and f₂−f₁, respectively) are generated within the tissue. The second harmonic signals 316 of the lower frequency (2f₁), and the difference frequency (f₂₋−f₁), respectively, are detected by the transducer. However, the method involves a long time interval 312 for pulse generation. Subsequently, the frame rate is slow, leading to low-quality imaging, especially in cases of tissue motion.

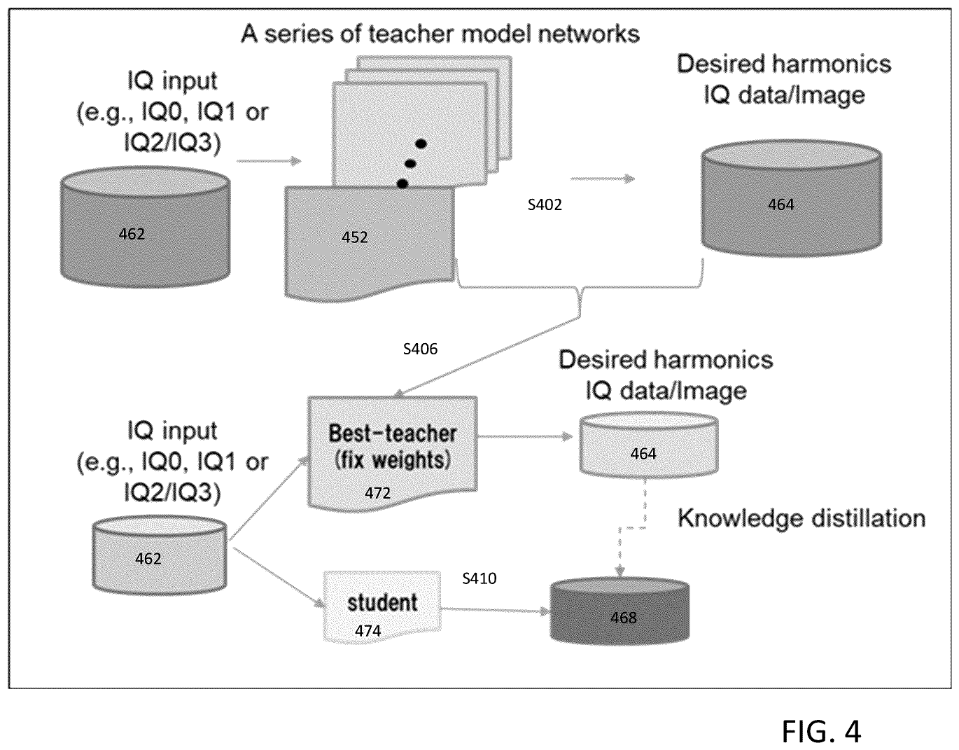

FIG. 4 is a flow diagram of one embodiment of off-line knowledge distillation.

In step S402, a plurality of heavy and powerful deep teacher models 452 is trained using various IQ input 462 and desired harmonics IQ data/image 464. In one embodiment, a deep learning-based framework for each teacher model is configured to input IQ data of various different combinations, as received by the transducer 202, and subject to data processing steps in computer system 204, and to output a desired image with improved image quality, fewer near-field artifacts, improved contrast, and deeper penetration. The deep learning-based framework can directly use second-or third-order harmonics, or alternatively, use data containing fundamental frequencies. The input IQ data can include a combination of a fundamental frequency signal, a second-order harmonics signal, and a third-order harmonics signal (IQ0). The IQ data can include a combination of fundamental ultrasound frequency and third-order harmonics (IQ1). The input IQ data can also include just a second-order harmonics signal (IQ2), or just a third-order harmonics signal (IQ3). The input IQ data can also be other higher-order harmonics greater than third order.

In step S406, data augmentation can be performed as necessary and each of the trained teacher networks 452 performs inferencing on a variety of testing data sets. For each data set, the teacher model having the best output result/feature map is chosen as the teacher model 472 to be used to train the lightweight student model 474 for that data set.

In step S410, using augmented data pairs (the IQ input 462 and knowledge distillation data 468, which comes from output data 464 of the best teacher model for the corresponding IQ input data 462), the student model 474 is trained for harmonic imaging.

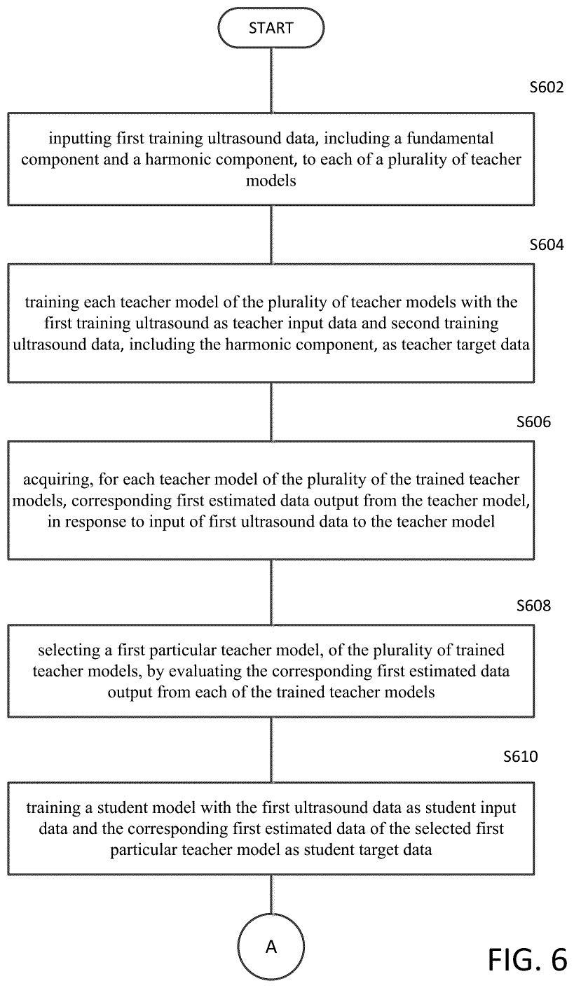

The off-line knowledge distillation process is further shown in the flowcharts of FIGS. 6-8. In FIG. 6, the training process includes, in step S602, inputting first training ultrasound data, including a fundamental component and a harmonic component, to each of a plurality of teacher models, and, in step S604, training each teacher model of the plurality of teacher models with the first training ultrasound as teacher input data and second training ultrasound data, including the harmonic component, as teacher target data.

In step S606, the method includes acquiring, for each teacher model of the plurality of the trained teacher models, corresponding first estimated data output from the teacher model, in response to input of first ultrasound data to the teacher model.

In step S608, the method includes selecting a first particular teacher model, of the plurality of trained teacher models, by evaluating the corresponding first estimated data output from each of the trained teacher models.

In step S610, training a student model with the first ultrasound data as student input data and the corresponding first estimated data of the selected first particular teacher model as student target data.

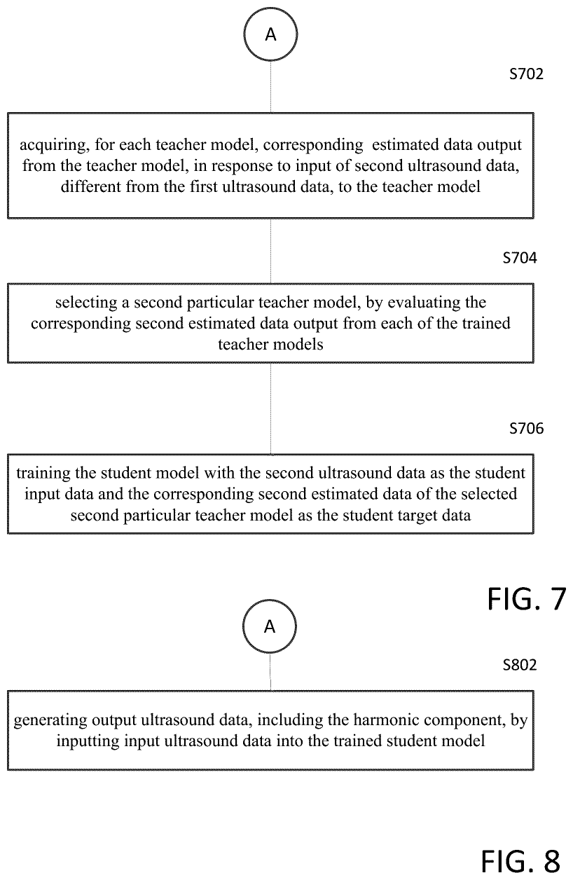

FIG. 7 is a flowchart of further steps of the method of FIG. 6. In step S702, the method includes acquiring, for each teacher model of the plurality of the trained teacher models, corresponding second estimated data output from the teacher model, in response to input of second ultrasound data, different from the first ultrasound data, to the teacher model.

In step S704, the method includes selecting a second particular teacher model, of the plurality of trained teacher models, by evaluating the corresponding second estimated data output from each of the trained teacher models.

In step S706, the method includes training the student model with the second ultrasound data as the student input data and the corresponding second estimated data of the selected second particular teacher model as the student target data.

FIG. 8 is a flowchart of further steps of FIG. 6. In step S802, the method includes generating output ultrasound data, including the harmonic component, by inputting input ultrasound data into the trained student model.

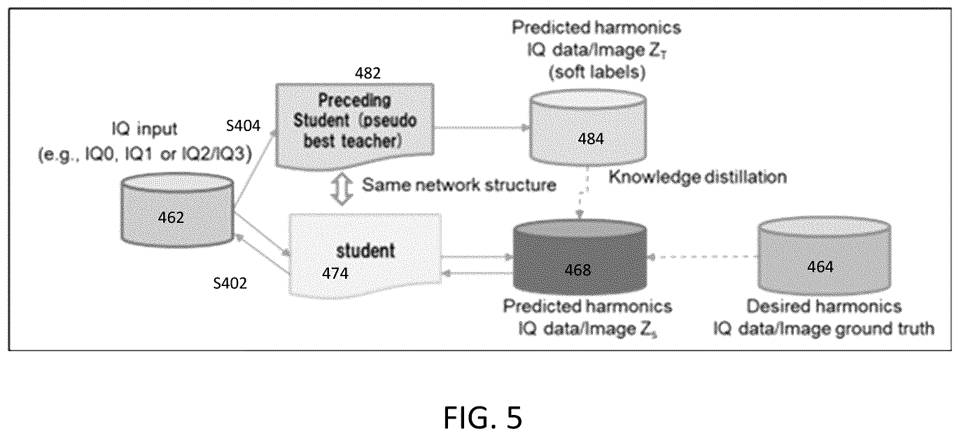

FIG. 5 is a flow diagram of one embodiment of the online self-knowledge distillation training process.

In step S402, IQ input data 462 can be preprocessed and then input to student model 474. The target IQ data corresponding to IQ input data 462 is data 464 shown in FIG. 5. In step S404, the same IQ input data 462 that was input to the student model is input to the pseudo best teacher model 482, which can be a previous best student model. Here, the student model 474 and the pseudo best teacher model 482 can have the same network structure and number of parameters, for example. The output 468 of the student model, the output 484 of the pseudo teacher model, and the desired/target output data 464 are used to compute a loss function value, which is then used to update the parameters of the student model 474. During the training of the student model 474, the parameters of the pseudo best teacher remain fixed.

In one embodiment, the online training process can be represented by the following pseudo code, in which (Fₛ,θₛ) represents the student model 474, where θₛ is the set of trainable parameters; (F_{T}, θ_{T}) represents the pseudo-teacher model 482, where θ_{T} is the set of frozen parameters; L(Z_{S}, y′; θs) is the loss between ground truth y′ (desired IQ output 464) and the student model output Z_{S}(468) for model input x′; L(Z_{S}, Z_{T}; θ_{S}) is the loss between the pseudo best teacher model output Z_{T} (484) and the student model output Z_{S} (468); and λ is loss weight.

Pseudo-code:

```
Initialization;
For Epoch = 1... N do
  For batch in training set, do
    Sample a batch (x,y) from the training set;
    Data preprocessing, e.g., augmentation to (x′, y′);
    Calculate network forward Z_{T} = F_{T} (x′; θ_{T}) 384; Z_{S} = F_{S}(x′; θ_{S});
    Evaluate weighted loss: Loss = L(Z_{S}, y′; θ_{S}) + λ L(Z_{S} ,Z_{T}; θ_{S});
    Calculate the backpropagation and update θ_{S};
  IF Validation_loss (F_{S}, θ_{S}) < Validation_loss (F_{T}, θ_{T}) then
θ_{T} = θ_{S} = θ*
  IF θ_{S} reached convergence requirement, Early Stop
```

Here the loss function weight λ can be a constant hyperparameter, or λ can be set as a function of epoch, e.g., step-wise, exponential, linear growth. Further, different loss functions can be utilized for calculating the weighted loss, such as MSE, MAE, feature-map based, or loss functions considering outlier detection for targets learnt from teachers containing noise, etc.

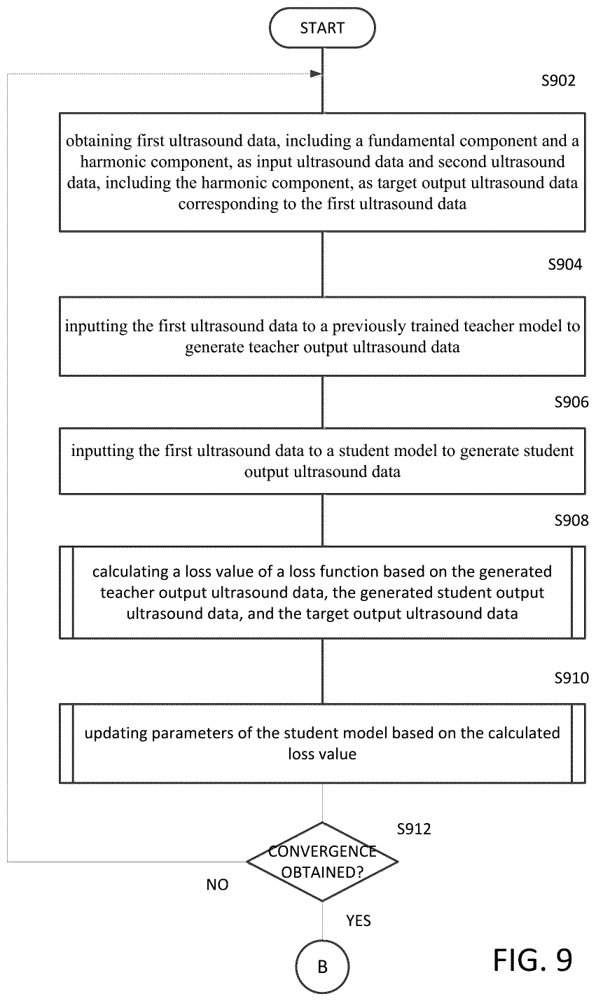

The on-line knowledge distillation process is further shown in the flowcharts of FIGS. 9-12.

FIG. 9 is a flowchart of a method of training a student model for ultrasound harmonic imaging.

The training process includes, in step S902, obtaining first ultrasound data, including a fundamental component and a harmonic component, as input ultrasound data and second ultrasound data, including the harmonic component, as target output ultrasound data corresponding to the first ultrasound data.

In step S904, the method includes inputting the first ultrasound data to a previously trained teacher model to generate teacher output ultrasound data.

In step S906, the method includes inputting the first ultrasound data to a student model to generate student output ultrasound data.

In step S908, the method includes calculating a loss value of a loss function based on the generated teacher output ultrasound data, the generated student output ultrasound data, and the target output ultrasound data.

In step S910, the method includes updating parameters of the student model based on the calculated loss value.

In step S912, the method repeats the obtaining, inputting, inputting, calculating, and updating steps for different input ultrasound data and corresponding different second ultrasound data until the parameters of the student model satisfy a convergence criteria.

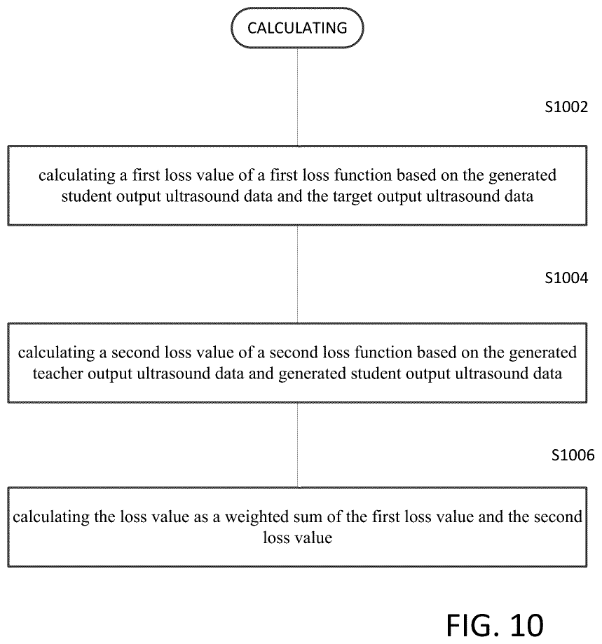

FIG. 10 is a flowchart of the calculating step of FIG. 9.

In step S1002, the method includes calculating a first loss value of a first loss function based on the generated student output ultrasound data and the target output ultrasound data.

In step S1004, the method includes calculating a second loss value of a second loss function based on the generated teacher output ultrasound data and generated student output ultrasound data.

In step S1006, the method includes calculating the loss value as a weighted sum of the first loss value and the second loss value.

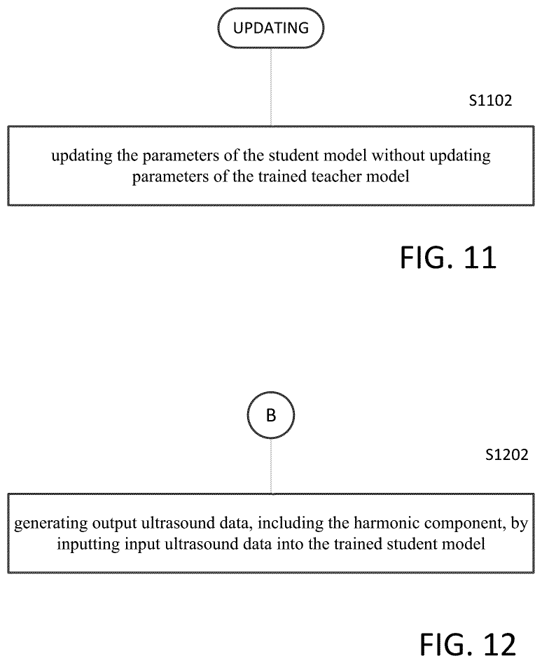

FIG. 11 is a flowchart of the updating step of FIG. 9. In step S1102, the method includes updating the parameters of the student model without updating parameters of the trained teacher model.

FIG. 12 is a flowchart for an inferencing step, according to an exemplary aspect of the disclosure. In step S1202, the method includes generating output ultrasound data, including the harmonic component, by inputting input ultrasound data into the trained student model.

In the present disclosure, there are different ways to do knowledge distillation for harmonic imaging based on different inputs and required outputs, including the following.
1. Directly use inverse pulse sequences to get IQ1 (fundamental+3^{rd} harmonics),and use the deep learning technology to extract 3rd harmonics to replace clinically used 2nd harmonic imaging. Then, with the teacher-student model, train a compact network for fast imaging.
2. Directly use 2^{nd and} 3^{rd} harmonic IQ data or images, to train a student network to obtain a desired target harmonic IQ data/images, including end-to-end training, and training a fusion map and calculate loss based on the fusion map.
3. Directly use IQ1 (fundamental+3^{rd} harmonics) and IQ2 (2^{nd} harmonic) data or images, to train a student model to obtain target IQ data/images, including end-to-end training, and training the network to obtain IQ3 from IQ1 and smartly fuse the estimated IQ3 with IQ2.
4. Directly use IQ0 (fundamental+2^{nd}+3^{rd} harmonics) to obtain target harmonic IQ data/images, including end-to-end training, and training the network to split IQ2 (2^{nd}) and IQ3 (3^{rd}) harmonics from IQ0, and output the desired IQ data/image.
5. For higher order harmonics, the framework can be extended to obtain higher order harmonic IQ data/images.

The disclosed method is aiming to use knowledge distillation for deep convolutional neural network to perform accelerated enhanced ultrasound tissue harmonic imaging. Conventional work on knowledge distillation is mostly on conventional computer vision classification problems, and is not directly suitable for ultrasound imaging and regression problems.

Both offline knowledge distillation as best teacher model and online self-knowledge distillation for best teacher are provided to train the light-weight student model for harmonic imaging. For offline training, the framework guarantees the best-performance teacher among multiple teacher models used for student training regardless of data diversity. For online training, the teacher network is not a fixed model with weights but dynamically evolves as the training proceed. Because of sharing the same structure as student, it saves time for on-line training compared with using a different structure teacher network.

As a result, the framework provides best performance teacher to minimize the gap between teacher and student, and also enhances the generalization capability of the lightweight student model. This is particularly useful for generating a robust and fast DCNN network for ultrasound harmonic imaging under various scan conditions, on different systems, even for those systems with limited computation power and bandwidth.

Depending on the inputs and task requirement, the method can provide harmonics with fewer artifacts, improved contrast, more penetration with accelerated frame rate. The methods can provide fast feature-aware depth-dependent harmonics, which is not necessarily to be pure harmonics or pure combined harmonics, but can also be enhanced harmonics (depth dependent, feature-aware) with significant reduced frame rate.

For ultrasound harmonic imaging, to obtain higher order harmonics, the traditional multiple pulse sequences method limits the frame rate and suffer from motion artifacts. Deep learning-based method could provide solution to obtain feature-aware superior harmonic image quality. However, direct implementation of deep network may prohibit its usage due to the requirement of intensive computation power and memory. The knowledge distillation framework provides a robust solution to solve sophisticated ultrasound harmonic imaging problem with accelerated imaging speed. A knowledge distillation framework for fast ultrasound harmonic imaging improves harmonic image quality while increasing frame rate.

In the present disclosure, a trained student network is used to obtain higher-order harmonics or enhanced harmonics with deep network transmitting less pulse sequences. Both the off-line and on-line best teacher training framework is provided for knowledge distillation in ultrasound harmonic imaging. The model accelerates the harmonic imaging, and can be easily implemented on ultrasound systems with limited computation power and memory. The model architecture is especially friendly to low-cost ultrasound systems, including portable ultrasound systems to perform high quality harmonic imaging.

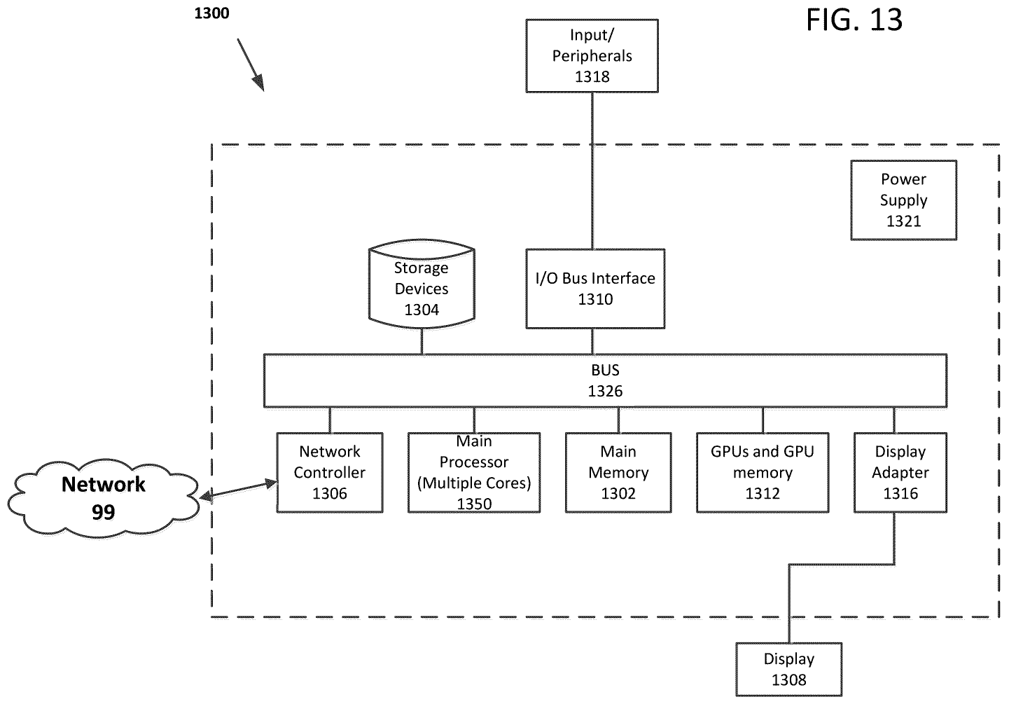

FIG. 13 is a block diagram illustrating an example computer system 204 for implementing the machine learning training and inference methods according to an exemplary aspect of the disclosure. The computer system may be an AI workstation running a server operating system, for example Ubuntu Linux OS, Windows Server, a version of Unix OS, or Mac OS Server. The computer system 1300 may include one or more central processing units (CPU) 1350 having multiple cores. The computer system 1300 may include a graphics board 1312 having multiple GPUs, each GPU having GPU memory. The graphics board 1312 may perform many of the mathematical operations of the disclosed machine learning methods. In other embodiments, the computer system 1300 may include a machine learning engine 1312. The machine learning engine 1312 may perform many of the mathematical operations of the disclosed machine learning methods. The computer system 1300 includes main memory 1302, typically random-access memory RAM, which contains the software being executed by the processing cores 1350 and GPUs 1312, as well as a non-volatile storage device 1304 for storing data and the software programs. Several interfaces for interacting with the computer system 1300 may be provided, including an I/O Bus Interface 1310, Input/Peripherals 1318 such as a keyboard, touch pad, mouse, Display Adapter 1316 and one or more Displays 1308 (206), and a Network Controller 1306 to enable wired or wireless communication through a network 99. The interfaces, memory and processors may communicate over the system bus 1326. The computer system 1300 includes a power supply 1321, which may be a redundant power supply.

In some embodiments, the computer system 1300 may include a server CPU and a graphics card by NVIDIA, in which the GPUs have multiple CUDA cores.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A method, comprising:
inputting first training ultrasound data, including a fundamental component and a harmonic component, to each of a plurality of teacher models, and training each teacher model of the plurality of teacher models with the first training ultrasound as teacher input data and second training ultrasound data, including the harmonic component, as teacher target data;
acquiring, for each teacher model of the plurality of the trained teacher models, corresponding first estimated data output from the teacher model, in response to input of first ultrasound data to the teacher model;
selecting a first particular teacher model, of the plurality of trained teacher models, by evaluating the corresponding first estimated data output from each of the trained teacher models; and
training a student model with the first ultrasound data as student input data and the corresponding first estimated data of the selected first particular teacher model as student target data.

2. The method of claim 1, wherein each of the plurality of trained teacher models has a different model structure and more parameters than the student model.

3. The method of claim 1, further comprising:
acquiring, for each teacher model of the plurality of the trained teacher models, corresponding second estimated data output from the teacher model, in response to input of second ultrasound data, different from the first ultrasound data, to the teacher model;
selecting a second particular teacher model, of the plurality of trained teacher models, by evaluating the corresponding second estimated data output from each of the trained teacher models; and
training the student model with the second ultrasound data as the student input data and the corresponding second estimated data of the selected second particular teacher model as the student target data.

4. The method of claim 3, wherein the selected second particular teacher model is different from the selected first particular teacher model.

5. The method of claim 1, further comprising:
generating output ultrasound data, including the harmonic component, by inputting input ultrasound data into the trained student model.

6. An apparatus, comprising:
processing circuitry configured to
input first training ultrasound data, including a fundamental component and a harmonic component, to each of a plurality of teacher models, and train each teacher model of the plurality of teacher models with the first training ultrasound as teacher input data and second training ultrasound data, including the harmonic component, as teacher target data;
acquire, for each teacher model of the plurality of the trained teacher models, corresponding first estimated data output from the teacher model, in response to input of first ultrasound data to the teacher model;
select a first particular teacher model, of the plurality of trained teacher models, by evaluating the corresponding first estimated data output from each of the trained teacher models; and
train a student model with the first ultrasound data as student input data and the corresponding first estimated data of the selected first particular teacher model as student target data.

7. The apparatus of claim 6, wherein each of the plurality of trained teacher models has a different model structure and more parameters than the student model.

8. The apparatus of claim 6, wherein the processing circuitry is further configured to:
acquire, for each teacher model of the plurality of the trained teacher models, corresponding second estimated data output from the teacher model, in response to input of second ultrasound data, different from the first ultrasound data, to the teacher model;
select a second particular teacher model, of the plurality of trained teacher models, by evaluating the corresponding second estimated data output from each of the trained teacher models; and
train the student model with the second ultrasound data as the student input data and the corresponding second estimated data of the selected second particular teacher model as the student target data.

9. The apparatus of claim 8, wherein the processing circuitry is further configured to select the second particular teacher model, which is different from the selected first particular teacher model.

10. The apparatus of claim 6, wherein the processing circuitry is further configured to generate output ultrasound data, including the harmonic component, by inputting input ultrasound data into the trained student model.

11. A method, comprising:
obtaining first ultrasound data, including a fundamental component and a harmonic component, as input ultrasound data and second ultrasound data, including the harmonic component, as target output ultrasound data corresponding to the first ultrasound data;
inputting the first ultrasound data to a previously trained teacher model to generate teacher output ultrasound data;
inputting the first ultrasound data to a student model to generate student output ultrasound data;
calculating a loss value of a loss function based on the generated teacher output ultrasound data, the generated student output ultrasound data, and the target output ultrasound data; and
updating parameters of the student model based on the calculated loss value.

12. The method of claim 11, wherein the calculating step further comprises:
calculating a first loss value of a first loss function based on the generated student output ultrasound data and the target output ultrasound data;
calculating a second loss value of a second loss function based on the generated teacher output ultrasound data and generated student output ultrasound data; and
calculating the loss value as a weighted sum of the first loss value and the second loss value.

13. The method of claim 11, further comprising repeating the obtaining, inputting, inputting, calculating, and updating steps for different input ultrasound data and corresponding different second ultrasound data until the parameters of the student model satisfy a convergence criteria.

14. The method of claim 11, wherein the updating step comprises updating the parameters of the student model without updating parameters of the trained teacher model.

15. The method of claim 11, further comprising:
generating output ultrasound data, including the harmonic component, by inputting input ultrasound data into the trained student model.

16. An apparatus, comprising:
processing circuitry configured to
obtain first ultrasound data, including a fundamental component and a harmonic component, as input ultrasound data and second ultrasound data, including the harmonic component, as target output ultrasound data corresponding to the first ultrasound data;
input the first ultrasound data to a previously trained teacher model to generate teacher output ultrasound data;
input the first ultrasound data to a student model to generate student output ultrasound data;
calculate a loss value of a loss function based on the generated teacher output ultrasound data, the generated student output ultrasound data, and the target output ultrasound data; and
update parameters of the student model based on the calculated loss value.

17. The apparatus of claim 16, wherein in calculating the loss value, the processing circuitry is further configured to:
calculate a first loss value of a first loss function based on the generated student output ultrasound data and the target output ultrasound data;
calculate a second loss value of a second loss function based on the generated teacher output ultrasound data and generated student output ultrasound data; and
calculate the loss value as a weighted sum of the first loss value and the second loss value.

18. The apparatus of claim 16, wherein the processing circuitry is further configured to repeat the obtaining, inputting, inputting, calculating, and updating steps for different input ultrasound data and corresponding different second ultrasound data until the parameters of the student model satisfy a convergence criteria.

19. The apparatus of claim 16, wherein in the updating, the processing circuitry is further configured to update the parameters of the student model without updating parameters of the trained teacher model.

20. The apparatus of claim 16, wherein the processing circuitry is further configured to:
generate output ultrasound data, including the harmonic component, by inputting input ultrasound data into the trained student model.
